(19) United States
(12) Patent Application Publication
(10) Pub. No.: US 2013/0145079 A1
(43) Pub. Date: Jun. 6, 2013

(54) MEMORY SYSTEM AND RELATED WEAR-LEVELING METHOD

(71) Applicants: CHULHO LEE, SUWON-SI (KR); SEIJIN KIM, SEONGNAM-SI (KR)

(72) Inventors: CHULHO LEE, SUWON-SI (KR); SEIJIN KIM, SEONGNAM-SI (KR)

(73) Assignee: SAMSUNG ELECTRONICS CO., LTD., SUWON-SI (KR)

(21) Appl. No.: 13/607,980

(22) Filed: Sep. 10, 2012

(30) Foreign Application Priority Data
Dec. 2, 2011 (KR) 10-2011-0128312

(51) Int. Cl. G06F 12/02

(52) U.S. Cl. 711/103; 711/E12.008

(57) ABSTRACT

A method is provided for performing wear-leveling in a memory system comprising a nonvolatile memory device and a memory controller configured to control the nonvolatile memory device. The method comprises setting a wear-level grade for each of a plurality of memory blocks based on a plurality of wear parameters, and determining an order in which to perform program and/or erase (P/E) operations on the memory blocks based on their respective wear-level grades.

### CROSS-REFERENCE TO RELATED APPLICATIONS

This application claims priority under 35 USC §119 to Korean Patent Application No. 10-2011-0128312 filed on Dec. 2, 2011, the subject matter of which is hereby incorporated by reference.

### BACKGROUND OF THE INVENTION

The inventive concept relates generally to electronic memory technologies. More particularly, the inventive concept relates to memory systems and related wear-leveling methods.

Semiconductor memory devices can be roughly divided into two categories according to whether they retain stored data when disconnected from power. These categories include volatile memory devices, which lose stored data when disconnected from power, and nonvolatile memory devices, which retain stored data when disconnected from power.

Nonvolatile memory devices have gained increasing popularity in recent years due to various factors such as increasing storage capacity and access speed, as well as an ever increasing demand for mobile electronic devices using nonvolatile memory, such as cellular phones, digital cameras, and tablet computers, to name but a few.

Among the more popular forms of nonvolatile memory is flash memory. Flash memory may provide several benefits, such as relatively high storage capacity, efficient access speed, low power consumption, and an ability to withstand physical shock. One of the drawbacks of flash memory, however, is that it has limited program/erase endurance, meaning that it may fail after it is programmed or erased many times. Accordingly, in an effort to enhance the lifetime of flash memory devices, memory systems are often designed to perform a technique referred to as wear-leveling. Wear-leveling generally involves distributing program and/or erase operations to different memory cells or memory blocks based on the number of times that they have been previously programmed or erased. The objective of wear-leveling is to substantially equalize, or “level”, the number of program and/or erase operations performed on different memory cells so that they wear out at substantially the same rate.

### SUMMARY OF THE INVENTION

In one embodiment of the inventive concept, a method is provided for performing wear-leveling in a memory system comprising a nonvolatile memory device and a memory controller configured to control the nonvolatile memory device. The method comprises setting a wear-level grade for each of a plurality of memory blocks based on a plurality of wear parameters, and determining an order in which to perform program and/or erase (P/E) operations on the memory blocks based on their respective wear-level grades.

In another embodiment of the inventive concept, a memory system comprises a nonvolatile memory device, and a memory controller configured to control the nonvolatile memory device and comprising an intelligent wear-leveling module configured to perform wear-leveling based on a plurality of wearout parameters comprising at least a number of errors occurring during read operations and a number of program/erase (P/E) cycles.

In another embodiment of the inventive concept, a method is provided for performing wear-leveling in a nonvolatile memory device comprising a plurality of memory blocks. The method comprises determining a memory block on which to perform a program or erase operation based on based on multiple wearout parameters associated with each of the memory blocks.

These and other embodiments of the inventive concept may potentially lead to more precise and accurate wear leveling, which can be used to improve the lifetime of nonvolatile memory devices.

### BRIEF DESCRIPTION OF THE DRAWINGS

The drawings illustrate selected embodiments of the inventive concept. In the drawings, like reference numbers indicate like features.

FIG. 1 illustrates a memory system according to an embodiment of the inventive concept.

FIG. 2 is a diagram of a memory block shown in FIG. 1 according to an embodiment of the inventive concept.

FIG. 3 is a block diagram illustrating an intelligent wear-leveling module in FIG. 1 according to an embodiment of the inventive concept.

FIG. 4 is a flowchart illustrating a wear-leveling method of the intelligent wear-leveling module in FIG. 3 according to an embodiment of the inventive concept.

FIG. 5 is a flowchart illustrating a wear-leveling method of the intelligent wear-leveling module in FIG. 3 according to another embodiment of the inventive concept.

FIG. 6 is a block diagram illustrating an intelligent wear-leveling module in FIG. 1 according to another embodiment of the inventive concept.

FIG. 7 is a block diagram illustrating an intelligent wear-leveling module in FIG. 1 according to another embodiment of the inventive concept.

FIG. 8 is a block diagram illustrating an intelligent wear-leveling module in FIG. 1 according to another embodiment of the inventive concept.

FIG. 9 is a block diagram illustrating an intelligent wear-leveling module in FIG. 1 according to another embodiment of the inventive concept.

FIG. 10 illustrates a block of a vertical NAND flash memory device (VNAND) according to an embodiment of the inventive concept.

FIGS. 11 through 17 illustrate various examples of systems incorporating a memory system according to embodiments of the inventive concept.

### DETAILED DESCRIPTION

Embodiments of the inventive concept are described below with reference to the accompanying drawings. These embodiments are presented as teaching examples and should not be construed to limit the scope of the inventive concept.

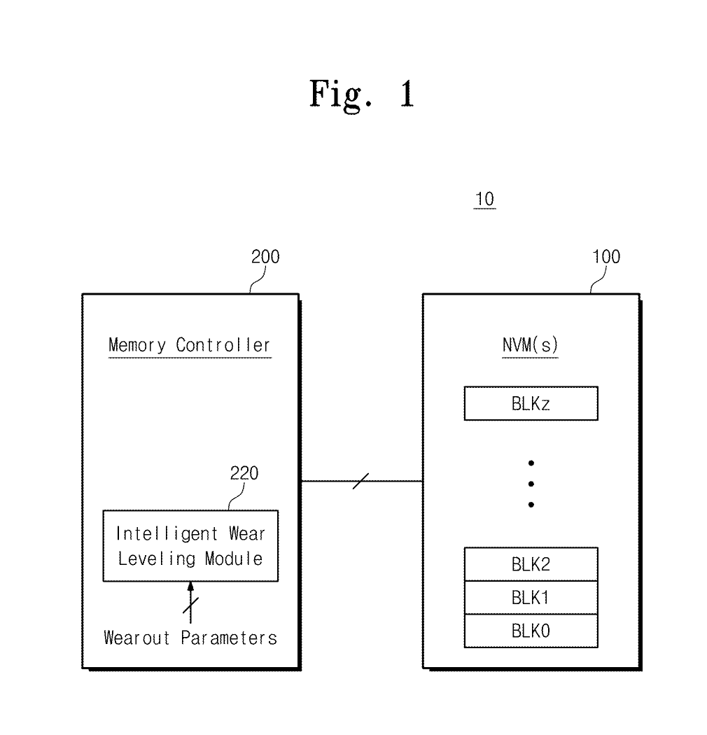

FIG. 1 is a block diagram of a memory system 10 according to an embodiment of the inventive concept.

Referring to FIG. 1, memory system 10 comprises a nonvolatile memory device 100 and a memory controller 200 configured to control nonvolatile memory device 100.

Nonvolatile memory device 100 comprises a plurality of blocks BLK0-BLKz for data storage. For explanation purposes, it will be assumed that nonvolatile memory device 100 comprises a NAND flash memory device, and therefore it may be referred to as NAND flash memory device 100. Nevertheless, nonvolatile memory device 100 may take many alternative forms, such as a vertical NAND flash memory (“VNAND”), a NOR flash memory device, a resistive random access memory (RRAM), a phase-change memory (PRAM), a magnetoresistive random access memory (MRAM), a ferroelectric random access memory (FRAM), or a spin transfer torque random access memory (STT-RAM), for example. In addition, nonvolatile memory 100 may be implemented with a two-dimensional or three-dimensional array structure. Where nonvolatile memory device 100 takes the form of a flash memory device, it may have a conductive floating gate used as a charge storage layer, or alternatively it may have a charge trap flash (CFT) memory device in which an insulating layer is used as a charge storage layer.

Memory controller 200 controls nonvolatile memory device 100. Memory controller 200 comprises an intelligent wear-leveling module 220 configured to manage the degree of wear of the respective blocks BLK0-BLKz. Intelligent wear-leveling module 220 evaluates the degree of wear of the respective blocks BLK0-BLKz based on a plurality of wearout parameters and performs wear-leveling based on the evaluated degree. The wear-leveling is intended to maintain the degree of wear of the respective blocks BLK0-BLKz at substantially the same level.

The wearout parameters may comprise, for example, the number of program/erase (P/E) cycles, ECC error information, temperature information of nonvolatile memory device 100, timing information from a start point of block programming to a current point, variation information of threshold voltage distribution of a predetermined flag cell, and the number of loops until an erase operation is completed. In some embodiments, at least one of the wearout parameters comprises the number of P/E cycles.

Intelligent wear-leveling module 220 manages the degree of wear of the respective blocks BLK0-BLKz using the wearout parameters. That is, intelligent wear-leveling module 220 sets a wear-level grade of the respective blocks BLK0-BLKz based on the degree of wear evaluated according to the wearout parameters, and it performs wear-leveling based on the set wear-level grade.

In general, wear-leveling allows the degree of wear of the respective blocks BLK0-BLKz to be maintained relatively equal by programming a block with the low degree of wear during a new program or copy operation. Examples of wear-leveling are disclosed in U.S. Pat. No. 8,028,121 and U.S. Patent Application Publication Nos. 2009-0077429, 2010-0027335, 2010-0115192, 2010-0246266, and 2011-0131367, the subject matter of which are all incorporated by reference in their entity.

A conventional memory system performs wear-leveling based solely on the number of P/E cycles of each memory block. The memory blocks may include healthy blocks including relatively durable cells, and weak blocks including relatively non-durable cells. The relatively durable cells are memory cells with relatively superior degradation properties, while the relatively non-durable cells are memory cells with poor degradation properties. The healthy blocks and the weak blocks have different endurance levels corresponding to different numbers of P/E cycles. Because a conventional memory system performs wear-leveling based on the number of P/E cycles, irrespective of block endurance, the reliability of the nonvolatile memory device may be affected by the presence of weak blocks.

In contrast, memory system 10 manages the degree of wear of blocks BLK0-BLKz based on at least two wearout parameters to perform wear-leveling more accurately or precisely than conventional memory systems. That is, memory system 10 may perform appropriate wear-leveling according to healthy and weak blocks (i.e., according to “health states” of blocks). For example, memory system 10 may treat a weak block with a predetermined number of P/E cycles as a bad block while treating a healthy block with the same number of P/E cycles as a good block. As a result, memory system 10 improves overall reliability of nonvolatile memory device 100 compared with a conventional memory system.

Stated another way, memory system 10 non-uniformly manages the number of P/E cycles of the respective blocks BLK0-BLKz according to the wear-level grade associated with a plurality of wearout parameters. Thus, memory system 10 may uniformly manage the degree of wear of the respective blocks BLK0-BLKz.

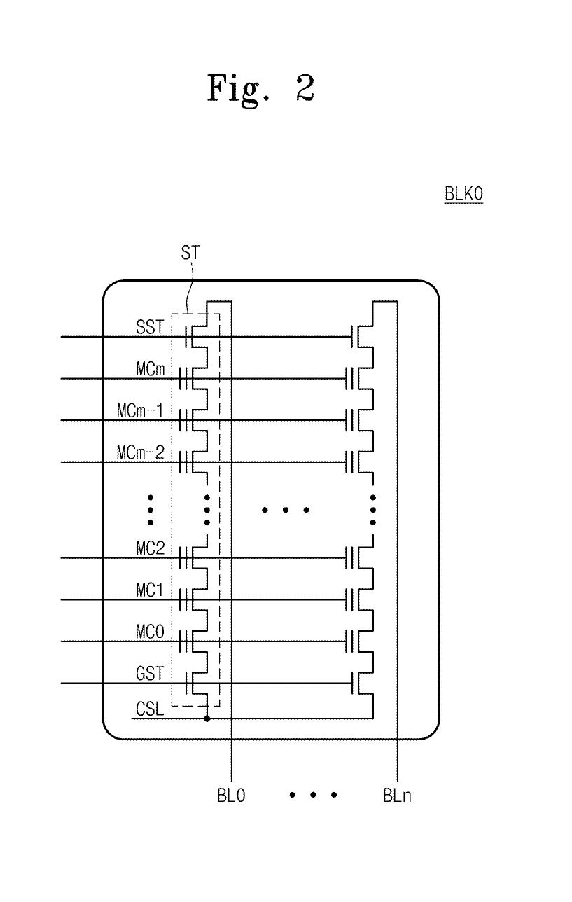

FIG. 2 illustrates an example of memory block BLK0 in FIG. 1.

Referring to FIG. 2, block BLK0 comprises at least one string ST connected to respective bitlines BL0-BLn. String ST comprises a string selection transistor SST, memory cells MC0-MCm, and a ground selection transistor GST, which are connected in series. String selection transistors SST are driven by voltages transferred through a string selection line SSL. Ground selection transistor GST is driven by voltages transferred through a ground selection line GSL. Each of memory cells MC0-MCm stores at least one bit of data. Memory cells MC0-MCm are driven by voltages transferred through corresponding wordlines WL0-WLm.

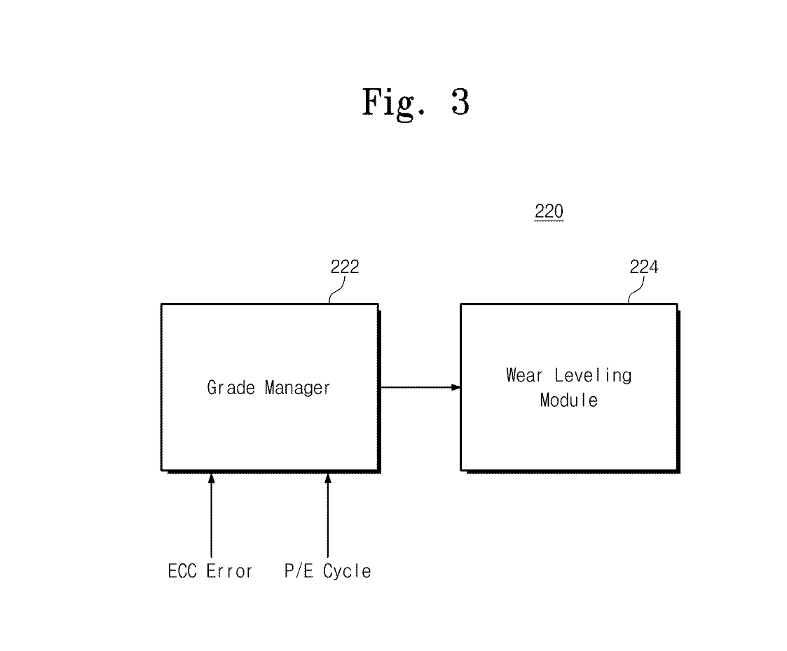

FIG. 3 is a block diagram illustrating an example of intelligent wear-leveling module 220 shown in FIG. 1.

Referring to FIG. 3, intelligent wear-leveling module 220 comprises a grade manager 222 and a wear-leveling module 224. Grade manager 222 determines a wear-level grade of a block based on ECC error information and the number of P/E cycles. The ECC error information may the number of errors detected when error correction is conducted during a read operation or the sum total of the detected errors. The ECC error information may be managed in the unit of blocks or pages. Wear-leveling module 224 stores the determined wear-level grade of a block in nonvolatile memory device 100 in the form of table or performs wear-leveling of blocks BLK0-BLKz based on the stored wear-level grade.

Intelligent wear-leveling module 220 determines a wear-level grade of a block based on ECC error information and the number of P/E cycles and performs wear-leveling based on the determined wear-level grade of a block.

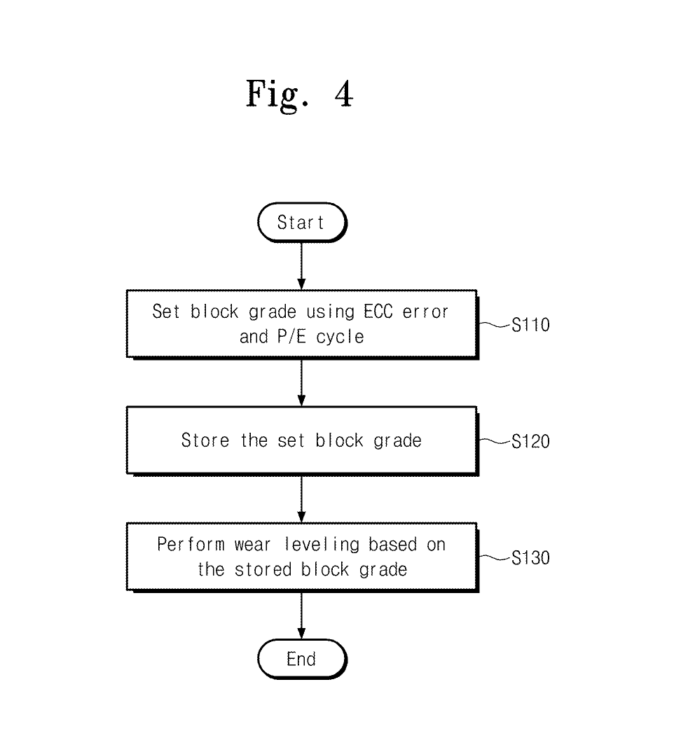

FIG. 4 is a flowchart illustrating a wear-leveling method of intelligent wear-leveling module 220 in FIG. 3 according to an embodiment of the inventive concept.

Referring to FIGS. 3 and 4, grade manager 222 sets a wear-level grade of a block using ECC error information and the number of P/E cycles (S110). Grade manager 222 sets a wear-level grade of a block based on information on a wear-level grade derived from a relationship between ECC error information and the number of P/E cycles through learning in advance. Each block may store ECC error information and the number of P/E cycles. The ECC error and the number of P/E cycles of each block may be stored in the form of table (hereinafter referred to as “wear parameter table”). That is, the wear parameter table may include ECC error information and the number of P/E cycles corresponding to each block.

The set wear-level grade of a block is stored in nonvolatile memory device 100 in the form of table (hereinafter referred to as “wear-level grade table”) (S120). That is, the wear-level grade table may include information on the wear-level grade corresponding to each block.

Wear-leveling module 224 performs wear-leveling based on the wear-level grade table associated with the wear-level grade (S130). The wear-leveling is typically performed periodically.

In the method of FIG. 4, a wear-level grade of a block is set based ECC error information and the number of P/E cycles and wear-leveling is performed based on the set wear-level grade.

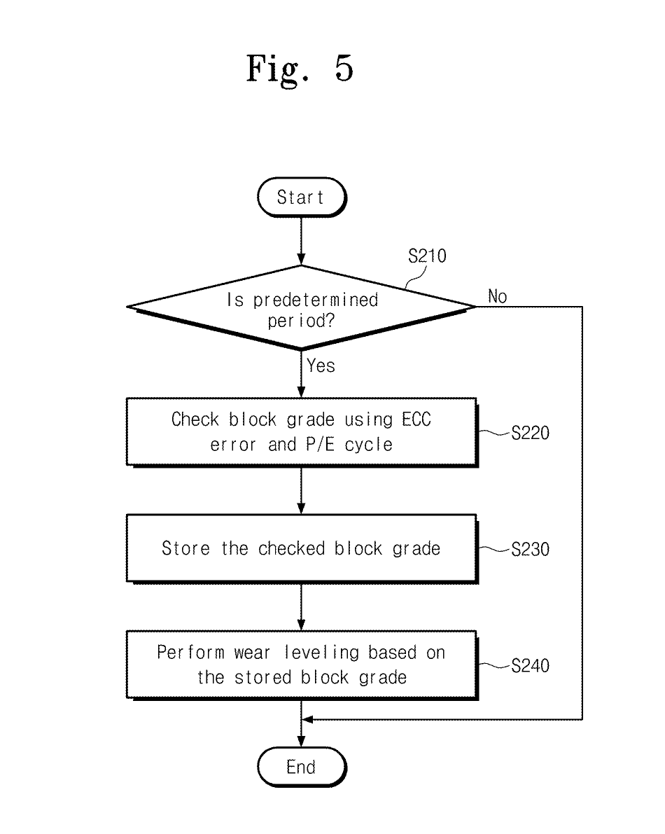

FIG. 5 is a flowchart illustrating a wear-leveling method of intelligent wear-leveling module 220 in FIG. 3 according to another embodiment of the inventive concept.

Referring to FIGS. 3 and 5, grade manager 222 determines whether a predetermined period is reached (S210). The predetermined period may be, for instance, a number of P/E cycles of a block. For example, grade manager 222 may determine whether the number of P/E cycles of a block is a multiple of N (N>1). Alternatively, the predetermined period may be a time interval that repeats from the start of an initial program operation of the memory block. In another embodiment, the predetermined period may be a time where the number of errors of the memory block is at least one predetermined value during a read operation.

Grade manager 222 checks a wear-level grade of the block using ECC error information and the number of P/E cycles (S220). The checked wear-level grade of the block is stored in nonvolatile memory device 100 in the form of table (hereinafter referred to as “wear-level grade table”) (S230). Wear-leveling module 224 performs wear-leveling based on the wear-level grade table associated with the wear-level grade (S240).

In the wear-leveling method of FIG. 5, a wear-level grade of a block is periodically set based on ECC error information and the number of P/E cycles and wear-leveling is performed based on the set wear-level grade.

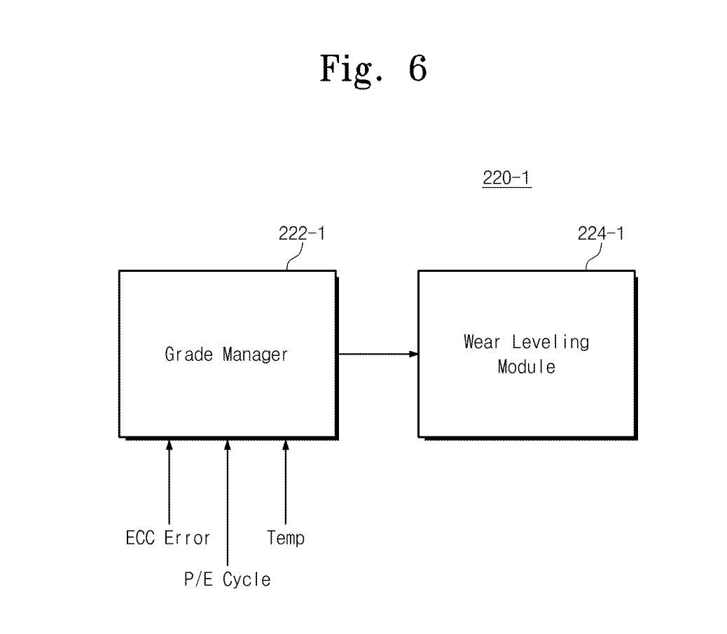

In certain examples explained with reference to FIGS. 3 to 5, a wear-level grade is determined based on ECC error information and the number of P/E cycles. However, the inventive concept is not limited to using this information. For example, various alternatives are explained below with reference to FIGS. 6 to 9.

FIG. 6 is a block diagram illustrating another example of intelligent wear-leveling module 220 of FIG. 1. In FIGS. 6 through 9, different versions of the features shown in FIG. 1 will be labeled with suffixes (e.g., grade-manager 222-1, 222-2, 222-3, etc.) to distinguish them from each other.

Referring to FIG. 6 grade manager 222-1 determines a wear-level grade of a block based on ECC error information, the number of P/E cycles, and temperature information. The temperature information may be a temperature of nonvolatile memory device 100.

In some embodiments, nonvolatile memory device 100 comprises a temperature sensor for measuring its temperature. The temperature sensor may measure the temperature in real time and transfer information on the measured temperature to grade manager 222-1 of memory controller 200. Alternatively, the temperature sensor may measure the temperature according to a request of memory controller 220 and transfer information on the measured temperature to grade manager 222-1. In some embodiments, each of blocks BLK0-BLKz of nonvolatile memory device 100 comprises a temperature sensor for measuring their respective temperatures.

In some embodiments, the wear-level grade table of blocks BLK0-BLKz comprises ECC error information and the number of P/E cycles. Grade manager 222-1 adjusts, corrects, or changes a wear-level grade of each block based on the wear-level grade table and the temperate information. Wear-leveling module 224-1 performs wear-leveling based on the adjusted wear-level grade.

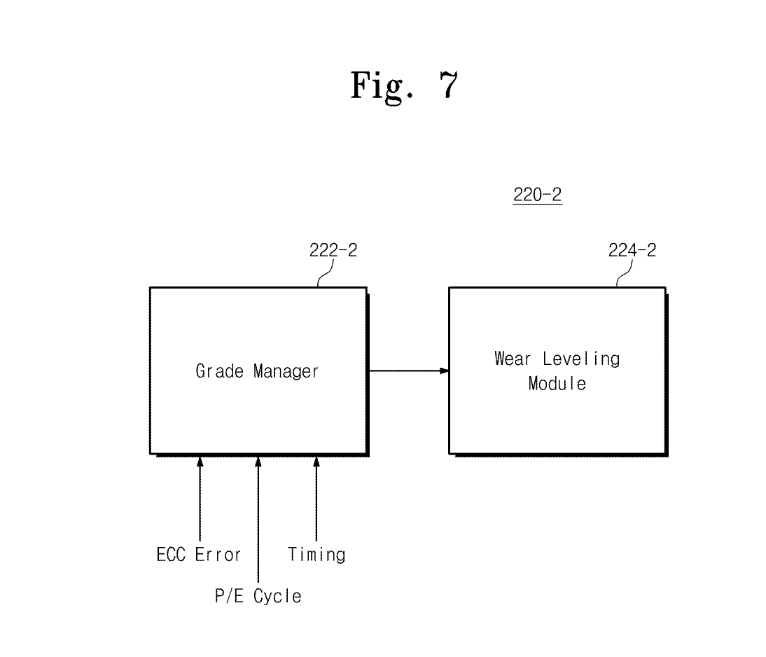

FIG. 7 is a block diagram illustrating another example of intelligent wear-leveling module 220 of FIG. 1.

Referring to FIG. 7, grade manager 222-2 determines a wear-level grade of a block based on ECC error information, the number of P/E cycles, and timing information. The timing information may be information associated with the timing when an initial program operation of the block is performed.

In some embodiments, a wear-level grade table of blocks BLK0-BLKz comprises ECC error information and the number of P/E cycles. Grade manager 222-2 adjusts, corrects, or changes a wear-level grade of each block based on the wear-level grade table and the timing information. Wear-leveling module 224-2 performs wear-leveling based on the adjusted wear-level grade.

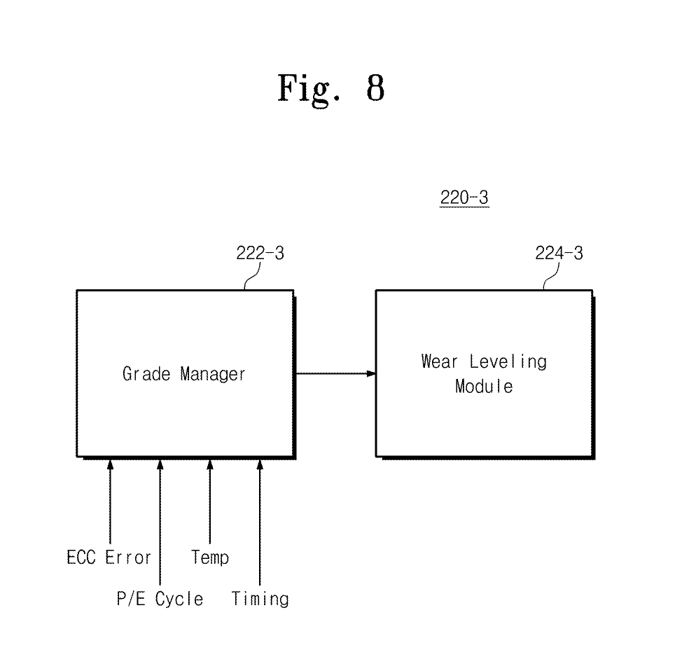

FIG. 8 is a block diagram illustrating another example of intelligent wear-leveling module 220 in FIG. 1.

Referring to FIG. 8, grade manager 222-3 determines a wear-level grade of a block based on ECC error information, the number of P/E cycles, temperature information, and timing information.

In some embodiments, a wear-level grade table of blocks BLK0-BLKz comprises ECC error information and the number of P/E cycles. Grade manager 222-3 adjusts, corrects, or changes a wear-level grade of the block based on the wear-level grade table, temperature information, and the timing information. Wear-leveling module 224-3 performs wear-leveling based on the adjusted wear-level grade.

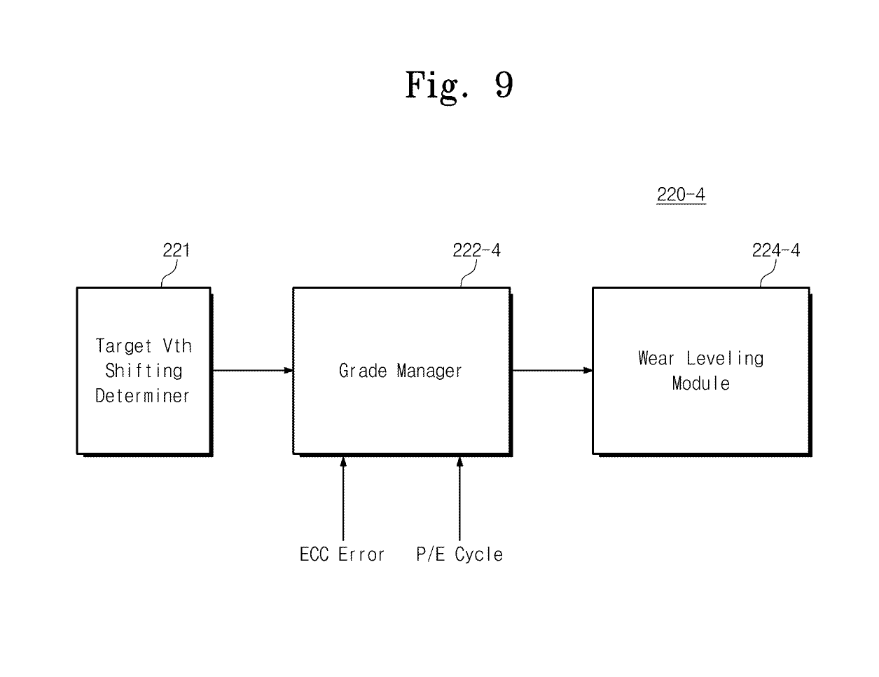

FIG. 9 is a block diagram illustrating another example of intelligent wear-leveling module 220-4 in FIG. 1.

Referring to FIG. 9, intelligent wear-leveling module 220-4 comprises a target threshold voltage shifting determiner 221, a grade manager 222-4, and a wear-leveling module 224-4.

Target threshold voltage shifting determiner 221 measures a degree of shifting in a threshold voltage of at least one cell in a corresponding block. Grade manager 222-4 determines a wear-level grade of a block based on ECC error information, the number of P/E cycles, and the measured threshold voltage shifting information. In some embodiments, a wear-level grade table of blocks BLK0-BLKz comprises ECC error information, the number of P/E cycles, and the measured threshold voltage shifting information. Wear-leveling module 224-4 performs wear-leveling based on the wear-level grade table.

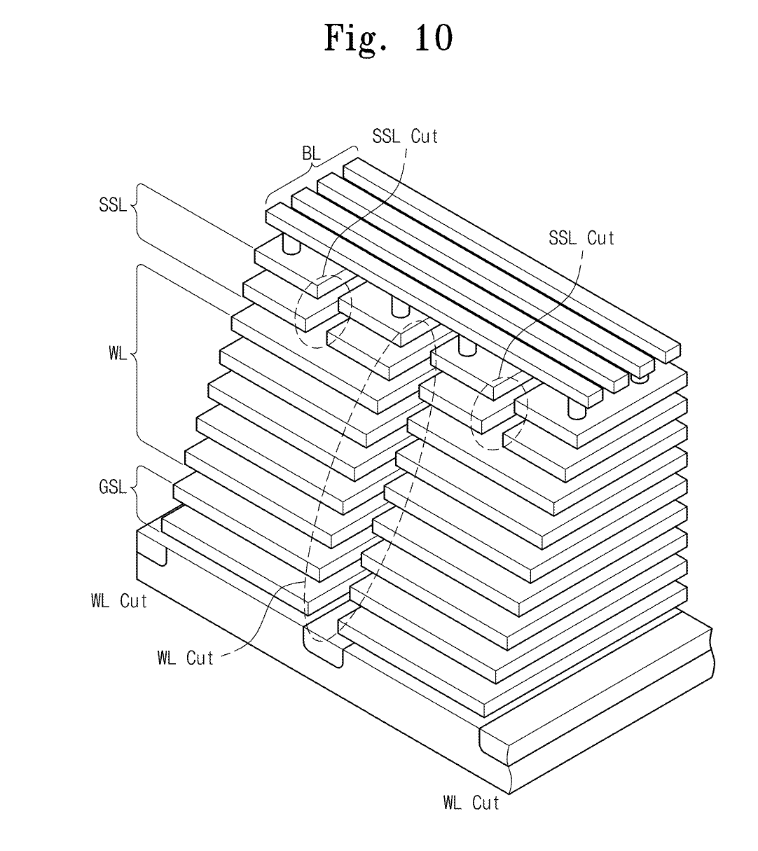

FIG. 10 is a diagram of a memory block in a vertical NAND flash memory device (VNAND) according to an embodiment of the inventive concept.

Referring to FIG. 10, the memory block is implemented as a wordline merging structure. Two ground string lines (GSL) GSL1 and GSL2, a plurality of wordlines WL, and two string selection lines (SSL) SSL1 and SSL2 are stacked between wordline cuts on a substrate. String selection lines SSL1 and SSL2 are divided by a string selection line cut.

A plurality of pillars penetrates ground selection lines GSL1 and GSL2, wordlines WL, and string selection lines SSL1 and SSL2. Ground selection line GSL, wordlines WL, and at least one of string lines SSL are implemented in the form of substrate. Bitlines are connected to top surfaces of the pillars.

Although string selection line SSL is implemented with two substrates as shown in FIG. 10, the inventive concept is not limited to this configuration. In general, string selection line SSL may be implemented with one or more substrates. Similarly, although ground selection line GSL is implemented with two substrates as shown in FIG. 10, the inventive concept is not limited to this configuration. In general, ground selection line GSL may be implemented one or more substrates.

Although block BLK is implemented as a wordline merging structure as shown in FIG. 10, the inventive concept is not limited to this configuration. Examples of various alternative block structures of the VNAND are disclosed in U.S. Patent Application Publications Nos. 2009-0310415, 2010-0078701, 2010-0117141, 2010-0140685, 2010-0213527, 2010-0224929, 2010-0315875, 2010-0322000, 2011-0013458, and 2011-0018036, the subject matter of which are all incorporated by references.

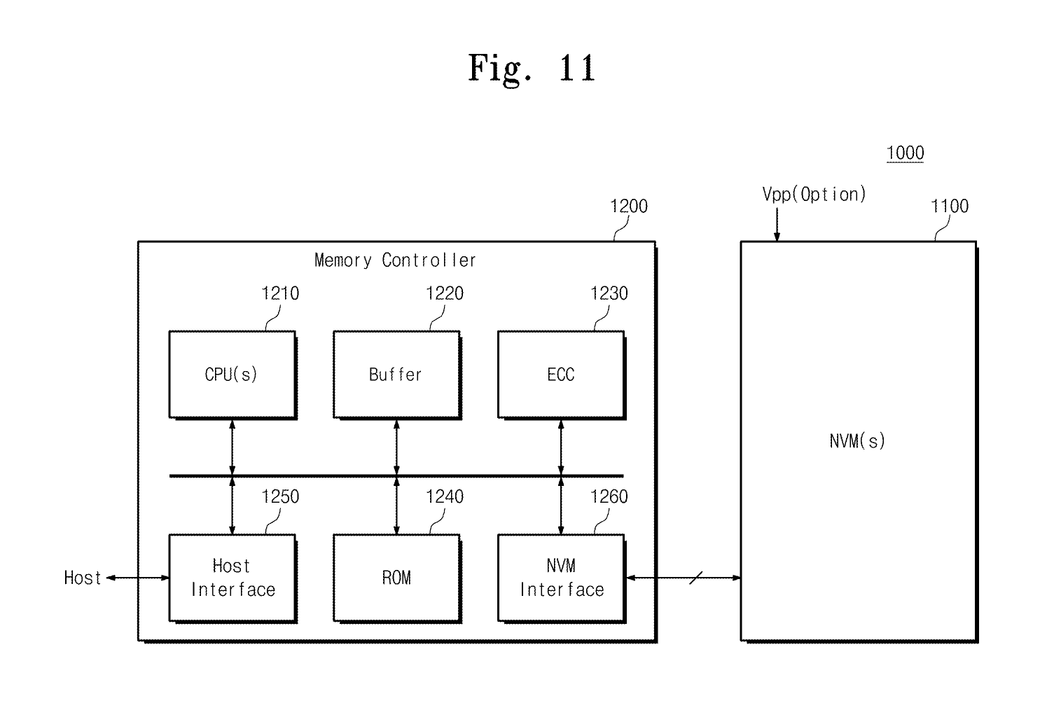

FIGS. 11 through 17 illustrate various examples of systems incorporating a memory system according to embodiments of the inventive concept.

Referring to FIG. 11 a memory system 1000 comprises at least one nonvolatile memory device 1100 and a memory controller 1200.

Nonvolatile memory device 1100 may be optionally supplied with a high voltage Vpp from an external source. Memory controller 1200 may be connected to nonvolatile memory device 1100 through a plurality of channels. Memory controller 1200 comprises at least one central processing unit (CPU) 1210, a buffer memory 1220, an ECC circuit 1230, a nonvolatile memory 1240, a host interface 1250, and a memory interface 1260. Nonvolatile memory 1240 may store intelligent wear-leveling module 220 in FIG. 1 in the form of program code, for example. Although not shown in FIG. 11, memory controller 1200 may further include a randomization circuit configured to randomize and de-randomize data. Memory system 1000 may be applied to a perfect page new (PPN) memory.

Examples of certain details of memory system 1000 are disclosed in U.S. Pat. No. 8,027,194 and U.S. Patent Application Publication No. 2010-0082890, the subject matter of which are hereby incorporated by reference.

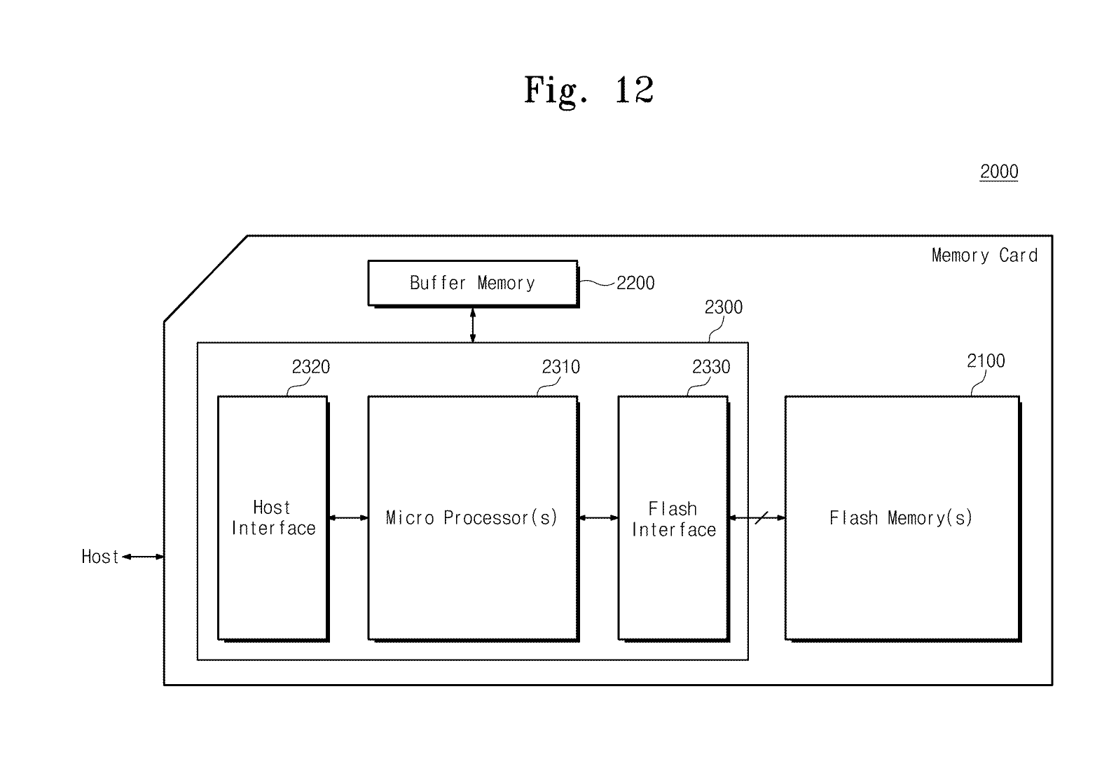

Referring to FIG. 12, a memory card 2000 comprises at least one flash memory device 2100, a buffer memory device 2200, and a memory controller 2300 configured to control flash memory 2100 and buffer memory 2200. Buffer memory device 2200 is used to temporarily store data generated during the operation of memory card 2000. Buffer memory device 2200 may be implemented using a dynamic random access memory (DRAM) or a static random access memory (SRAM), for example.

Flash memory device 2100 may be optionally supplied with an external high voltage Vpp. Memory controller 2200 is connected to flash memory device 2100 through a plurality of channels. Memory controller 2300 is coupled between a host and flash memory device 2100. Memory controller 2300 accesses flash memory 2100 in response to a request from the host.

Memory controller 2300 comprises at least one microprocessor 2310, a host interface 2320, and a flash interface 2330. The at least one microprocessor 2310 is configured to drive firmware. Host interface 2320 may interface with the host through a card protocol (e.g., SD/MMC) for data exchange between the host and memory card 2000.

Memory card 2000 may be applied to multimedia cards (MMCs), security digitals (SDs), miniSDs, memory sticks, smartmedia, and transflash cards.

Examples of certain details of memory card 2000 are disclosed in U.S. Patent Application Publication No. US 2010-0306583, the subject matter of which is hereby incorporated by reference.

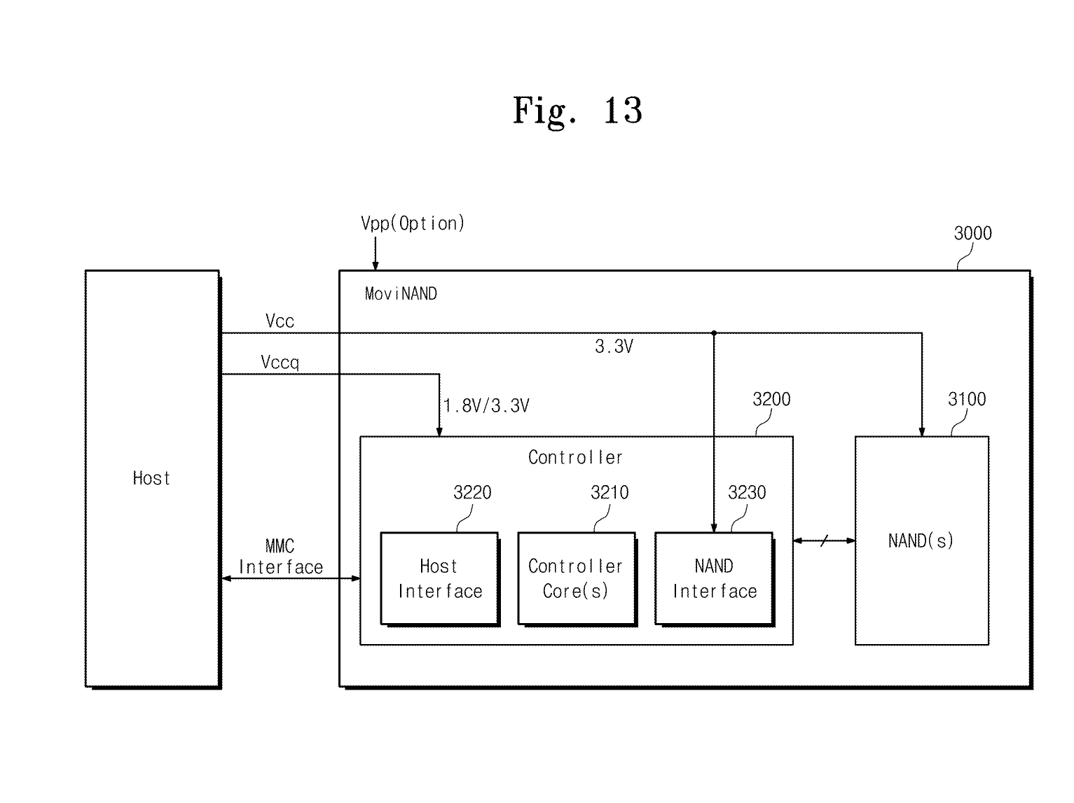

Referring to FIG. 13 a moviNAND 30000 comprises at least one NAND flash memory device 3100 and a controller 3200. MoviNAND device 3000 supports MMC 4.4 (called eMMC) standard, and it may be implemented with features similar to memory system 10 of FIG. 1.

NAND flash memory device 3100 may be a single data rate (SDR) or double data rate (DDR) NAND flash memory device. In some embodiments, NAND flash memory device 3100 comprises unitary NAND flash memory devices, which may be stacked within a package such as a fine-pitch ball grid array (FBGA).

Memory controller 3200 is connected to flash memory device 3100 through a plurality of channels. Controller 3200 comprises at least one controller core 3210, a host interface 3220, and a NAND interface 3230. The at least one controller core 3210 controls overall operation of moviNAND device 3000. Host interface 3220 provides an interface between controller 3210 and a host. NAND interface 3250 facilitates communication between NAND flash memory device 3100 and controller 3200. In some embodiments, host interface 3220 comprises a parallel interface (e.g., an MMC interface). In certain alternative embodiments, host interface 3220 of moviNAND 3000 comprises a serial interface (e.g., UHS-II or UFS interface).

MoviNAND device 3000 receives first and second power supply voltages Vcc and Vccq from the host. First power supply voltage Vcc (about 3.3 volts) is supplied to NAND flash memory device 3100 and NAND interface 3230, while the second power supply voltage Vccq (about 1.8 volt/3.3 volts) is supplied to controller 3200. In some embodiments, moviNAND 3000 is optionally supplied with an external high voltage Vpp.

MoviNAND 3000 may provide benefits in storing large amounts of data, and it may also have improved read characteristics. In addition, MoviNAND 3000 may be applied to compact and low-power mobile products (e.g., Galaxy S, iPhone, etc.).

Although moviNAND 3000 be supplied with a plurality of power supply voltages Vcc and Vccq, the inventive concept is not limited to this configuration. For example, the moviNAND may be implemented to generate a power supply voltage (e.g., 3.3 volts) suitable for a NAND interface and a NAND flash memory by internally boosting or regulating an input power supply voltage Vcc. Examples of internal boosting or regulating operations are disclosed in U.S. Pat. No. 7,092,308, the subject matter of which is hereby incorporated by reference.

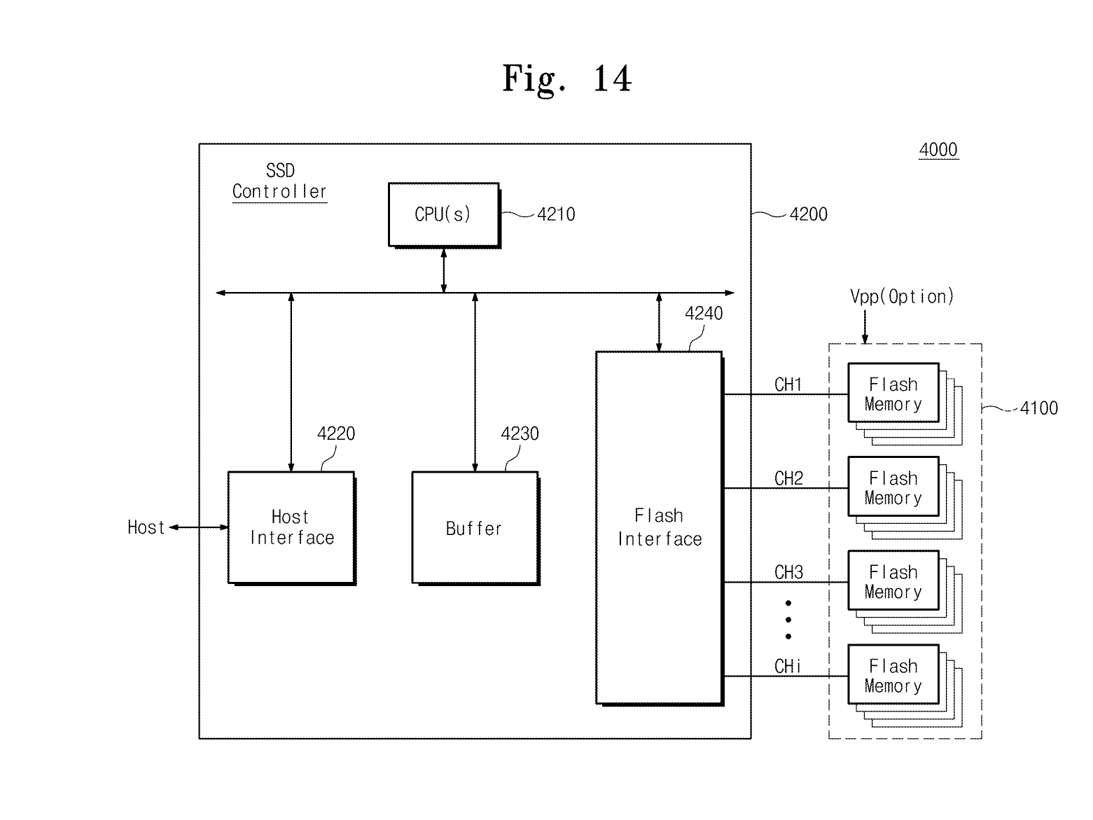

Referring to FIG. 14, a solid state disk (SSD) 4000 comprises a plurality of flash memory devices 4100 and an SSD controller 4200. SSD 4000 may be implemented with the features similar to memory system 10 of FIG. 1.

Flash memory devices 4100 may be optionally supplied with an external high voltage Vpp. SSD controller 4200 may be connected to flash memory devices 4100 through a plurality of channels CH1 to CHi (i>1). SSD controller 4200 comprises at least one central processing unit (CPU) 4210, a host interface 4220, a buffer memory 4230, and a flash interface 4240.

Under the control of CPU 4210, host interface 4220 exchanges data with a host through the communication protocol. In some embodiments, the communication protocol comprises the Advanced Technology Attachment (ATA) protocol. The ATA protocol may include a Serial Advanced Technology Attachment (SATA) interface, a Parallel Advanced Technology Attachment (PATA) interface, an External SATA (ESATA) interface, and the like. In some embodiments, the communication protocol comprises the Universal Serial Bus (UBS) protocol. Data input from the host through host interface 4220 or data to be transferred to the host may be transferred through buffer memory 4230 without bypassing a CPU bus under the control of CPU 4210.

Buffer memory 4230 can be used to temporarily store data transferred between an external entity and flash memory devices 4100. In addition, buffer memory 4230 may be used to store programs to be executed by CPU 4210. Buffer memory 4230 can be implemented by a DRAM or an SRAM, for example. Although buffer memory 4230 may be included inside SSD controller 4200, the inventive concept is not limited to this configuration. For example, buffer memory 4230 may alternatively be provided outside SSD controller 4200.

Flash interface 4240 facilitates communication between SSD controller 4200 and flash memory devices 4100 used as storage devices. Flash interface 4240 may be configured to support NAND flash memories, One-NAND flash memories, multi-level flash memories, and single-level flash memories.

SSD 4000 performs an integrity program operation to reduce power consumption during a heating problem. Consequently, SSD 4000 may improve reliability of the stored data. The detailed description of SSD 4000 is disclosed in U.S. Pat. No. 8,027,194 and U.S. Patent Application Publication No. 2010-0082890, the subject matter of which is hereby incorporated by reference.

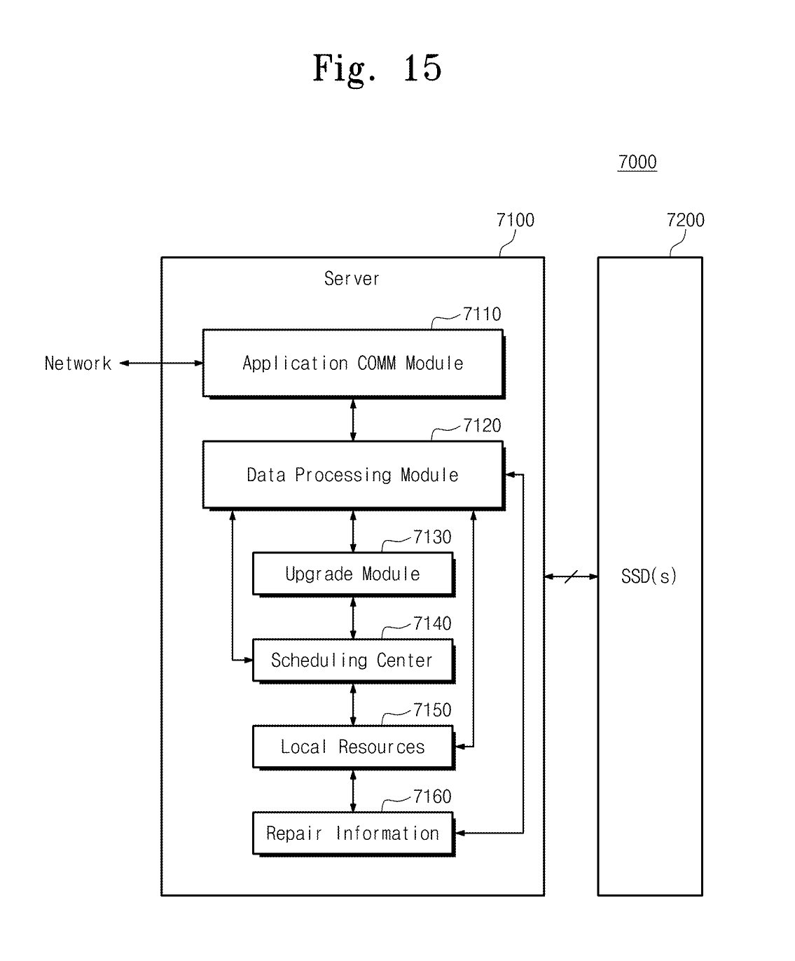

Referring to FIG. 15 a server system 7000 comprises a server 7100 and at least one SSD 7200 configured to store data required for driving server 7100. The at least one SSD 7200 can be implemented with the same configuration and operation as SSD 4000 in FIG. 14.

Server 7100 comprises an application communication module 7110, a data processing module 7120, an upgrade module 7130, a scheduling center 7140, a local resource module 7150, and a repair information module 7160. Application communication module 7110 is configured to communicate with a computing system connected to a network and server 7100 or to allow server 7100 to communicate with SSD 7200. Application communication module 7110 transmits data or information provided through a user interface to data processing module 7120.

Data processing module 7120 is linked to local resource module 7150. Local resource module 7150 may provide a list of repair shops/dealers/technical information to a user, based on information or data input to server 7100. Upgrade module 7130 interfaces with data processing module 7120. Based on information or data transferred from SSD 7200, upgrade module 7130 loads firmware, reset code, diagnosis system or other information upgrade on electronic appliances.

Scheduling center 7140 provides real-time options to the user based on the information or data input to server 7100. Repair information module 7160 interfaces with data processing module 7120. Repair information module 7160 is used to provide repair-related information (e.g., audio, video or document files) to the user. Data processing module 7120 packages related information based on the information transferred from SSD 7200, and the packaged information is transferred to SSD 7200 or displayed to the user.

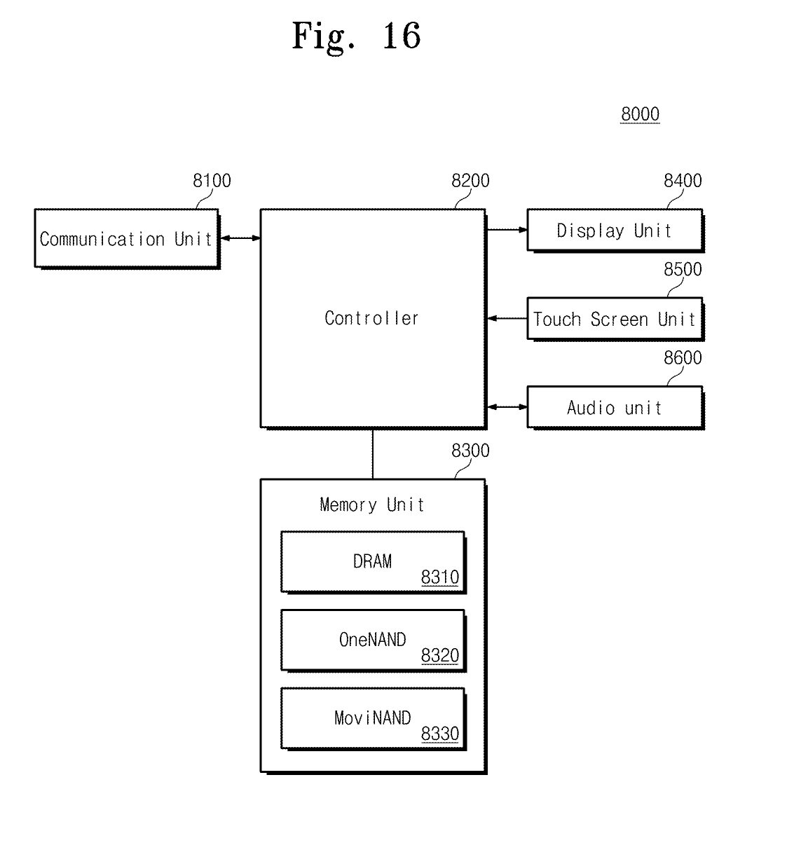

Referring to FIG. 16, a mobile device 8000 comprises a communication unit 8100, a controller 8200, a memory unit 8300, a display unit 8400, a touch screen unit 8500, and an audio unit 8600.

Memory unit 8300 comprises at least one DRAM 8310, at least one OneNAND 8320, and at least one moviNAND 8330. At least one of OneNAND 8320 and moviNAND 8330 may be implemented with the same configuration and operation as memory system 10 in FIG. 1.

Examples of certain details of mobile device 8000 are disclosed in U.S. Patent Application Publications Nos. 2010-0010040, 2010-0062715, 2010-0309237, and 2010-0315325, the subject matter of which are hereby incorporated by reference.

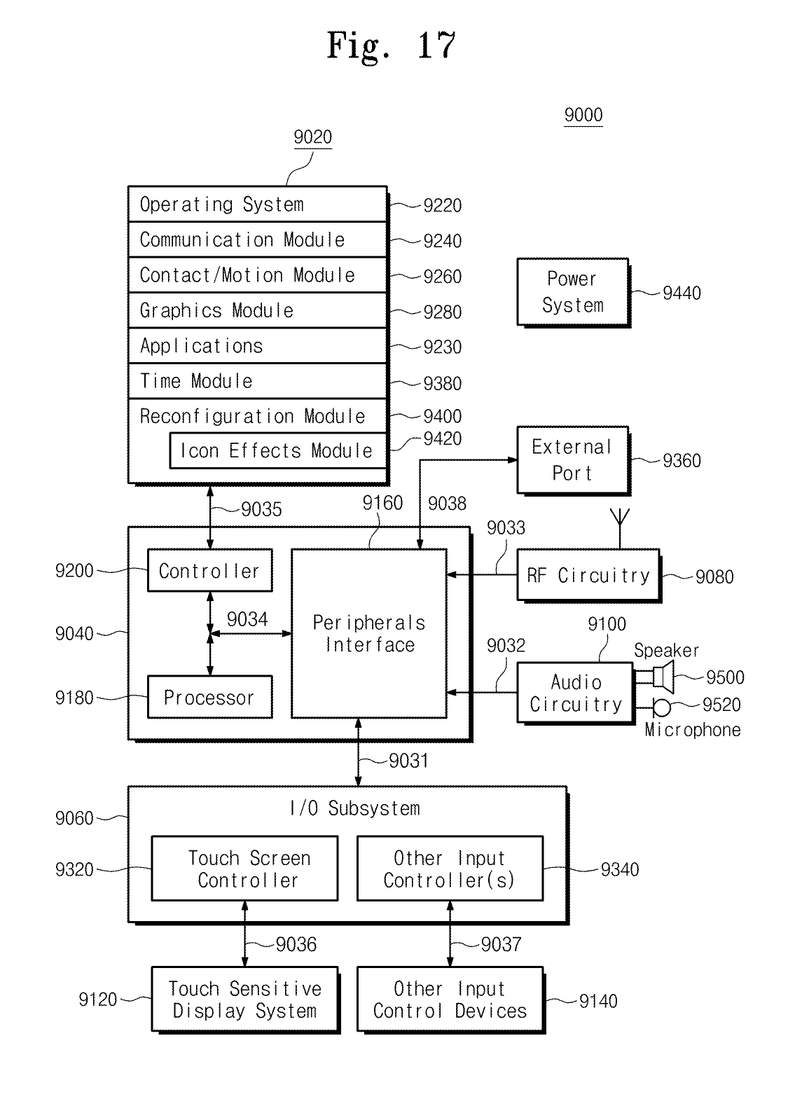

Referring to FIG. 17, a handheld electronic device 9000 comprises at least one computer-readable medium 9020, a processing system 9040, an input/output subsystem 9060, a radio frequency circuit 9080, and an audio circuit 9100. These features are interconnected by at least one communication bus or a signal line 9030. Handheld electronic device 9000 further comprises a power system 9440.

Computer-readable medium 9020 stores an operating system 9220, a communication module 9240, a contact motion module 9260, a graphics module 9280, an applications module 9230, a time module 9380, a reconfiguration module 9400, and an icon effects module.

Processing system 9040 comprises a controller 9200, a processor 9180, and a peripherals interface, which are connected to each other via a bus 9034. Input/output subsystem 9060 comprises a touch screen controller 9320 and other input controller(s) 9340, which are respectively connected to a touch sensitive display system 9120 and other input control devices 9140 via respective buses 9036 and 9037.

Audio circuitry 9100 is connected to processing system 9040 via a bus 9032, and it has an input/output interface connected to a speaker 9500 and a microphone 9520.

Radio frequency circuit 9080 is connected to processing system 9040 via a bus 9033. Processing system 9040 is connected to computer-readable medium 9020 via a bus 9035. An external port 9360 is connected to processing system 9040 via a bus 9038. Input/output subsystem is connected to processing system 9040 via a bus 9031.

Handheld electronic device 9000 can be any portable electronic device, including examples such as a handheld computer, a tablet computer, a cellular phone, a media player, a personal digital assistant (PDA) or a combination of at least two thereof. The at least one computer readable medium 9020 may be implemented with features similar to memory system 10 of FIG. 1.

Examples of certain details of handheld electronic device 9000 are disclosed in U.S. Pat. No. 7,509,588, the subject matter of which is hereby incorporated by reference.

The above-described memory systems or storage devices may be mounted in various alternative types of packages. Examples of such packages or package types include Package on Package (PoP), Ball Grid Arrays (BGAs), Chip Scale Packages (CSPs), Plastic Leaded Chip Carrier (PLCC), Plastic Dual In-line Package (PDIP), Die in Waffle Pack, Die in Wafer Form, Chip On Board (COB), Ceramic Dual In-line Package (CERDIP), Plastic Metric Quad Flat Pack (MQFP), Thin Quad Flat Pack (TQFP), Small Outline Integrated Circuit (SOIC), Shrink Small Outline Package (SSOP), Thin Small Outline Package (TSOP), System In Package (SIP), Multi Chip Package (MCP), Wafer-level Fabricated Package (WFP), and Wafer-level Processed Stack Package (WSP).

As indicated by the foregoing, a memory system and a wear-leveling method may use a plurality of wearout parameters to manage the degree of wear of a nonvolatile memory device with improved precision and accuracy.

The foregoing is illustrative of embodiments and is not to be construed as limiting thereof. Although a few embodiments have been described, those skilled in the art will readily appreciate that many modifications are possible in the embodiments without materially departing from the novel teachings and advantages of the inventive concept. Accordingly, all such modifications are intended to be included within the scope of the inventive concept as defined in the claims.

What is claimed is:

1. A method of performing wear-leveling in a memory system comprising a nonvolatile memory device and a memory controller configured to control the nonvolatile memory device, comprising:
setting a wear-level grade for each of a plurality of memory blocks based on a plurality of wear parameters; and
determining an order in which to perform program and/or erase (P/E) operations on the memory blocks based on their respective wear-level grades.

2. The method of claim 1, wherein the wearout parameters comprise at least two of a number of errors occurring during a read operation of a selected memory block, a number of P/E cycles of the selected memory block, temperature information of the nonvolatile memory device, information on time elapsed since an initial program operation performed on the selected memory block, and threshold voltage shifting information of at least one cell for checking the degree of wear of the selected memory block.

3. The method of claim 1, wherein setting a wear-level grade for each of the plurality of memory blocks further comprises determining whether a predetermined period is reached with respect to a selected memory block.

4. The method of claim 3, wherein the predetermined period corresponds to a predetermined number of program operations being performed on the selected memory block.

5. The method of claim 3, wherein the predetermined period corresponds to a predetermined amount of time elapsed since an initial program operation performed on the selected block.

6. The method of claim 3, wherein the predetermined period corresponds to a time in which at least a predetermined number of errors occurs in read operations of the selected memory block.

7. The method of claim 1, wherein the respective wear-level grades are stored in the nonvolatile memory device as a table.

8. The method of claim 1, further comprising adjusting the respective wear-level grades of the memory blocks based on stored wear-level grades and the wearout parameters and performing wear-leveling using the adjusted wear-level grades.

9. A memory system comprising:
a nonvolatile memory device; and
a memory controller configured to control the nonvolatile memory device and comprising an intelligent wear-leveling module configured to perform wear-leveling based on a plurality of wearout parameters comprising at least a number of errors occurring during read operations and a number of program/erase (P/E) cycles.

10. The memory system of claim 9, wherein the memory controller comprises an error correction code (ECC) circuit configured to detect and correct errors of data read during the read operation.

11. The memory system of claim 9, wherein the intelligent wear-leveling module comprises:
a grade manager configured to receive the number of the errors and the number of P/E cycles and periodically determine a wear-level grade of a memory block in the nonvolatile memory device; and
a wear-leveling module configured to perform wear-leveling using the determined wear-level grade.

12. The memory system of claim 9, wherein the intelligent wear-leveling module comprises:
a grade manager configured to receive the number of the errors, the number of P/E cycles, and temperature information of the nonvolatile memory device and periodically determine a wear-level grade of a memory block in the nonvolatile memory device; and
a wear-leveling module configured to perform wear-leveling using the determined wear-level grade.

13. The memory system of claim 9, wherein the intelligent wear-leveling module comprises:
a grade manager configured to receive the number of the errors, the number of P/E cycles, and time information passed from the start of performing an initial program operation on a block and periodically determine a wear-level grade of the block; and
a wear-leveling module configured to perform wear-leveling using the determined wear-level grade.

14. The memory system of claim 9, wherein the intelligent wear-leveling module comprises:
a grade manager configured to receive the number of the errors, the number of P/E cycles, temperature information of the at least one nonvolatile memory device, and information indicating an elapsed time since an initial program operation of a memory block in the nonvolatile memory device, and further configured to periodically determine a wear-level grade of the memory block; and
a wear-leveling module configured to perform wear-leveling based on the determined wear-level grade.

15. The memory system of claim 9, wherein the intelligent wear-leveling module comprises:
a target threshold voltage shifting determiner configured to periodically determine threshold voltage shifting information of at least one cell of a memory block in the nonvolatile memory device;
a grade manager configured to receive the number of the errors, the number of P/E cycles, and the threshold voltage shifting information and determine a wear-level grade of the memory block; and
a wear-leveling module configured to perform wear-leveling using the determined wear-level grade.

16. The memory system of claim 9, wherein the intelligent wear-leveling module non-uniformly manages the number of P/E cycles of respective memory blocks in the nonvolatile memory device according to a wear-level grade associated with the wearout parameters to uniformly manage wear-level grades of the respective memory blocks.

17. A method of performing wear-leveling in a nonvolatile memory device comprising a plurality of memory blocks, comprising:
determining a memory block on which to perform a program or erase operation based on based on multiple wearout parameters associated with each of the memory blocks.

18. The method of claim 17, wherein a first parameter among the multiple wearout parameters indicates a relative program and/or erase endurance of each memory block, and a second parameter among the multiple wearout parameters indicates a number of program and/or erase cycles that have been performed on each memory block.

19. The method of claim 18, wherein the first parameter is determined according to errors detected in read operations of the memory blocks.

20. The method of claim 17, wherein at least one of the multiple wearout parameters indicates a temperature of each of the memory blocks.
